(19) United States
(12) Patent Application Publication
(10) Pub. No.: US 2021/0000066 A1
(43) Pub. Date: Jan. 7, 2021

(54) Pet Bed With Solid Non-Woven Outer Cover

(71) Applicants: Howard Green, Carmel, IN (US); Erika Green, Carmel, IN (US)

(72) Inventors: Howard Green, Carmel, IN (US); Erika Green, Carmel, IN (US)

(21) Appl. No.: 15/929,690

(22) Filed: May 15, 2020

Related U.S. Application Data
(63) Continuation of application No. 62/867,823, filed on Jun. 27, 2019.

(51) Int. Cl. A01K 1/035; B68G 5/00

(52) U.S. Cl. CPC A01K 1/0353; B68G 5/00

(57) ABSTRACT

A pet bed with a solid, non-woven outer shell that makes the pet bed essentially waterproof and odor proof. The pet bed does not require and is not used with a waterproof liner, and thus it does not require the removal and re-insertion of any pet bed foam fill or cushion for cleaning of the pet bed. Preferably, the outer shell is a silicone, polyurethane, or other similar synthetic, solid, non-woven material safe for pets.

In a preferred form, the pet bed is impermeable to water and pests, does not absorb odor, spills, body fluids or bacteria and is essentially maintenance free due to the non-porous quality of the outer shell. The pet bed is highly resistant to pet biting and scratching, is suitable for indoor or outdoor use and is mobile, ideal for travel.

### CROSS-REFERENCE TO RELATED APPLICATIONS

This application is related to commonly owned Application No. 62/867,823 filed Jun. 27, 2019 entitled Pet Bed With Solid Non-Woven Outer Cover.

### FEDERALLY SPONSORED RESEARCH OR DEVELOPMENT

None.

### TECHNICAL FIELD

The present invention relates to pet beds, and more specifically, but not exclusively, to pet beds constructed with a solid, non-woven, outer shell that surrounds an inner cushioning material in a non-removable fashion so as to provide a pet bed that is waterproof, odor proof, and/or more easy to clean that existing pet beds.

### BACKGROUND OF THE INVENTION

Pet beds are cushions used by animals, and they come in a variety of well-known shapes and sizes. Many pet beds are the flat, mattress-type pet beds, which consist of a single foam pad, or that are surrounded on two or more sides by a bolster, made from a variety of materials, covered by a cover, which is usually removable for machine washing and requires that the foam insert is removed, cover is washed and foam re-inserted back into the cover.

The user frequently encounters other problems when he/she tries to re-insert the pad and bolsters into the newly washed and dried mattress cover. Even if the cover is form fitted to the pad and bolster, it is often quite difficult to slide the pad and bolster into the cover, as the blown foam will catch on the inside of the cover and tears. Once the user manages to cram the foam pad and bolster inside the cover, because of the tendency of the foam to catch on the inside of the cover the user frequently has to drastically compress the foam to cram it inside of the cover. Once the foam has been stuffed into the cover, it usually uncompresses in a form that does not fit the cover, requiring further compression/movement of the foam or attempted shifting of the cover. These actions usually result in further tearing of the foam and a permanent lack of fit between the foam pad and bolster and the cover. Thus, many pet owners, having attempted unsuccessfully to clean the cover and reassemble the foam and cover, resort to treating pet beds as disposable items, throwing away the old bed after several months of soiling, and replace it with a new one, rather than hassle with trying to replace the pad and bolsters inside a cleaned cover. Also, after a number of washings, the cover, the foam, or a zipper can be easily damaged during washing, drying or manipulation.

Waterproof pet beds available on the market are either made by encasing a foam cushion in a waterproof liner and covered by a washable cover or made of waterproof fabric that requires essentially the same maintenance to remove stains and odor and is susceptible to same wear and tear damage resulting from the frequent washing.

### DESCRIPTION OF THE RELATED ART INCLUDING INFORMATION DISCLOSED UNDER 37 CFR 1.97 AND 37 CFR 1.98

The following U.S. patents and published applications disclosing efforts at improved pet beds are incorporated by reference herein.

U.S. Pat. No. 5,226,384 to Jordan discloses a damage and pet-resistant animal bed in which the cover is an aramid fabric sheet with a polyester fabric sheet laminated to it.

U.S. Pat. No. 5,685,257 to Feibus discloses a pet support cushion that is made waterproof by inserting an impermeable inner layer under an outer layer that is absorbent.

U.S. Pat. No. 5,033,408 to Langenbahn discloses a pet bed having a cushion with a quick changeable cover. The cushion can be protected by inserting a waterproof backing under the cover.

U.S. Pat. No. 7,444,958 to Quinn discloses a pet bed with elevated dishes and cushions with adjustable supports. A foam pad is covered by a waterproof liner under the cover, and the different parts can be separated so as to be washable separately.

U.S. Pat. No. 9,986,717 to Diskin discloses a pet bed made of a cushion with a fabric cover.

U.S. Pat. No. 8,225,746 to Song discloses a pet bed with a fabric shell as the outer layer.

U.S. Pat. No. 7,185,604 to Holte discloses an orthopedic pet cushion that is made of a stain-resistant fabric material.

### BRIEF SUMMARY OF THE INVENTION

The invention is preliminarily shown and described in this non-formal provisional patent application in the accompanying brief written description and figures, which may include photographs and sketches.

According to one aspect, the invention is directed toward a pet bed with a solid, non-woven outer shell that makes the pet bed essentially waterproof and odor proof. The pet bed does not require and is not used with a waterproof liner, and thus it does not require the removal and re-insertion of any pet bed foam fill or cushion for cleaning of the pet bed. Preferably, the outer shell is a silicone, polyurethane, or other similar synthetic, solid, non-woven material safe for pets.

In a preferred form, the pet bed is impermeable to water and pests, does not absorb odor, spills, body fluids or bacteria and is essentially maintenance free due to the non-porous quality of the outer shell. The bed may be constructed such that the inner cushion or foam fill is essentially permanently encased in the outer shell, such that there are not multiple components that the user would wash separately and then need to reassemble before reuse. The pet bed is preferably highly resistant to pet biting and scratching, is suitable for indoor or outdoor use and is mobile, ideal for travel.

Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF THE DRAWINGS

The accompanying figures, drawings, and photographs illustrate certain aspects of example embodiments of the invention.

FIG. 1 shows a cross-sectional view of an exemplary pet bed.

### DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

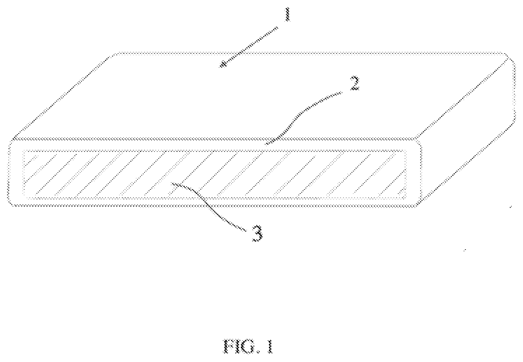

A pet bed 1 according to the present invention depicted in FIG. 1. The pet bed 1 has an outer shell 2 surrounding an inner cushioning material or foam fill 3. The outer shell surrounds the inner cushion material in a non-removable fashion, meaning there are no zippers or similar closure mechanisms to facilitate removal of the outer shell from the inner cushion material during use. Moreover, there is no separate outer cover provided with the pet bed, and thus it is to be understood that, during use, the pet would lay down and be in contact directly with the outer shell 2. As explained more fully below, the material of the outer shell provides the pet bed with a number of desirable properties.

An aspect of the invention is the outer shell material. Preferably, the outer shell 2 is made from a solid, non-porous, non-fabric synthetic material. In a preferred from, the shell 2 is made from a silicone or polyurethane material. The outer shell is thick enough to provide resistance from pet destructive behavior but still preserve its soft qualities. The outer shell is soft and comfortable to any pet, especially one with a fur.

The inner foam fill 3 may be made of any material that provides support, pressure relief and comfort. The inner fill 3 may be a single material or a combination of materials that provide the desired cushioning and fill the interior of the bed 1. The fill 3 may be encased in and/or attached permanently to the outer shell 2.

During construction, the outer shell may be formed in a suitable shape with an opening at one end to receive the fill. Then the fill 3 may be inserted into the outer shell 2, and then the opening in the outer shell may be sealed so as to permanently encase the fill in the outer shell. The fill may be attached to the outer shell by adhesion, insertion, injecting the foam material in its liquid form directly into the outer shell, allowing it to fill in spaces within the shape of the shell as it solidifies or any other process that will permanently encase the foam fill 3 in the outer shell 2. It is to be understood that there are no zippers, clasps, or other openable and closable aspects to the outer cover 2 that would allow the outer shell 2 to be removed from the inner foam fill 3 by the user.

Because the outer shell is made of non-woven, non-fabric, solid, impervious plastic material, it prevents dirt, liquids, stains or odor to accumulate. This solid cover thus makes the present pet bed relatively maintenance free, in that the bed is rinseable but there is no need to wash it like conventional fabric pet beds (i.e. in a washing machine). The present bed is water imperious, antimicrobial, odor resistant, scratch resistant, suitable for indoor and outdoor use, and cooling to the pet in summer months. The provision of this solid, non-woven outer shell is in contrast to prior art pet beds that rely on a woven outer shell or woven outer cover, where these woven outer materials are prone to picking up odors and typically require the removal of the cover for washing and rinsing to remove odor and dirt.

Any of the suitable technologies set forth and incorporated herein may be used to implement various example aspects of the invention as would be apparent to one of skill in the art. For example, it is expressly contemplated that any of the prior art pet beds referenced herein could be adapted to incorporate the present invention by modifying their designs to have a non-woven, solid outer cover according to the principles of the present invention. The size and shape of the pet bed can be substantially the same as those known in the art, such as rectangular, round, oval. The bed can be generally flat or provided with bolsters, as is also known in the art.

Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

What is claimed is:

1. A pet bed substantially as shown and described herein.

2. A pet bed consisting essentially of:
a. A resilient inner material(s), and
b. An outer shell covering and surrounding the resilient inner material;
c. Wherein the outer shell encases the inner material on all sides in a non-removable fashion (e.g. devoid of any zippers, snaps or similar features for facilitating removal and replacement of the outer shell by the user);
d. Wherein the resilient inner material fits snugly within the outer covering;
e. Wherein the outer shell comprises a solid and non-woven material such as silicone, polyurethane or other synthetic, solid, non-woven material safe for pets.

3. The use of a cushion substantially as shown and described herein as a bed for a pet.
